(19) United States
(12) Patent Application Publication
(10) Pub. No.: US 2025/0296115 A1
(43) Pub. Date: Sep. 25, 2025

(54) SYSTEM AND PROCESS FOR CURING A WET COATING APPLIED TO A SUBSTRATE

(71) Applicants: ANDREW LEGAULT, Les Coteaux (CA); AYOTTE TECHNO-GAZ INC., Saint-Alphonse-de-Rodriguez (CA)

(72) Inventors: Daniel AYOTTE, Saint-Alphonse-de-Rodriguez (CA); Andrew LEGAULT, Les Coteaux (CA)

(21) Appl. No.: 18/863,450

(22) PCT Filed: Nov. 12, 2023
(86) PCT No.: PCT/CA2023/050658

§ 371 Date: Nov. 6, 2024

Related U.S. Application Data
(60) Provisional application No. 63/364,663, filed on May 13, 2022.

(51) Int. Cl. B05D 3/02; F26B 3/28; F26B 3/30; F27B 9/02; F27B 9/14; F27B 9/36; F27D 3/12; F27D 9/00; F27D 99/00

(52) U.S. Cl. CPC B05D 3/0209; B05D 3/0263; F26B 3/283; F26B 3/305; F27B 9/028; F27B 9/14; F27B 9/36; F27D 3/12; F27D 9/00; F27D 99/0035; F26B 2210/16; F27B 2009/026; F27D 2009/0075; F27D 2099/0045; F27D 2099/005

(57) ABSTRACT

The present disclosure concerns a system for curing a wet coating of a coated substrate, the system comprising: a curing room having a curing room inlet and a curing room outlet, the curing room being configured to receive the coated substrate being introduced at the curing room inlet thereof along a first displacement axis, the system comprising a conveyor assembly for conveying the coated substrate through the curing room along a second displacement axis transverse to the first displacement axis, wherein the system further comprises a gas catalytic IR system, provided in the curing room, for producing an infrared radiation to partially cure the wet coating while the coated substrate is in the curing room. The disclosure concerns also a corresponding process.

### TECHNICAL FIELD

The technical field relates to systems and processes for curing a film of wet coating, such as a water-based coating or a solvent-based coating, applied to a substrate, such as a wood substrate. More particularly, the technical field relates to systems and processes for curing a film of wet coating applied to a substrate using gas catalyst infrared radiation systems.

### BACKGROUND

It is known to use electric infrared radiation to accelerate curing of a film of coating or powder, such as paint, applied to a substrate, such as to a metallic substrate. Infrared energy is a form of radiation, which falls between visible light and microwaves in the electromagnetic spectrum. Like other forms of electromagnetic energy, infrared travels in waves and there is a known relationship between the wavelength, frequency and energy level. That is, the energy (i.e., the temperature) increases as the wavelength decreases.

Unlike convection, which first heats air to transmit energy to the substrate, infrared energy can be absorbed directly by the coating or powder, which prevents the substrate from being damaged by reaching high temperatures. Gas catalytic infrared (IR) systems can deliver medium to long wave radiation so as to cure wet coatings applied to substrate, for instance wood substrate. Indeed, a gas catalytic IR heater is a flameless heat source that uses chemical reactions to break down molecules and produce heat. In the presence of a catalyst, catalytic combustion occurs when a combustible gas (e.g., a gaseous hydrocarbon such as natural gas, propane, butane, etc.), in the presence of an oxidizer gas (e.g., oxygen), produces carbon dioxide, water, and heat. The ignition temperature of the combustible gas occurs at substantially low temperatures. Therefore, no flame is involved in the combustion process and instead infrared waves are created, producing radiant heat.

There are still a number of challenges in using gas catalyst infrared radiation systems for curing films of wet coating applied to substrates.

In view of the above, there is a need for a system and a process for curing a wet coating applied to a substrate which would be able to overcome or at least reduce some of the prior art concerns.

### BRIEF SUMMARY

It is therefore an aim of the present invention to at least partially address some of the prior art issues.

According to a general aspect, there is provided a system for curing a wet coating of a coated substrate, the system comprising a curing room having a curing room inlet and a curing room outlet, the curing room being configured to receive the coated substrate, and the coated substrate being introduced at the curing room inlet thereof along a first displacement axis, the system comprising a conveyor assembly for conveying the coated substrate through the curing room along at least a second displacement axis transversal transverse to the first displacement axis, and wherein the system further comprises a gas catalytic infrared (IR) system, provided in the curing room, for producing an infrared IR radiation to partially cure the wet coating while the coated substrate is being displaced through the curing room along the second displacement axis.

According to another general aspect, there is provided a system for curing a wet coating of a coated substrate, the system comprising a curing room configured to receive the coated substrate and dividable along a curing displacement axis into at least: an upstream curing section comprising an upstream catalytic infrared (IR) heating system for producing an upstream IR radiation at an upstream radiation intensity to partially cure the wet coating; and a downstream curing section comprising a downstream catalytic IR heating system for producing a downstream IR radiation at a downstream radiation intensity, to further cure the wet coating; a conveyor assembly for conveying the coated substrate from the upstream curing section towards the downstream curing section along the curing displacement axis; and for displacing the coated substrate in a substantially vertical direction in at least one of the upstream and downstream curing sections.

According to another general aspect, there is provided a process for curing a wet coating of a coated substrate, the process comprising introducing the coated substrate in an upstream curing section of a curing room along a first displacement axis; in the upstream curing section, producing an upstream infrared (IR) radiation at an upstream radiation intensity using an upstream catalytic IR heating system to partially cure the wet coating; displacing the coated substrate along a second displacement axis transverse to the first displacement axis from the upstream curing section to a downstream curing section of the curing room; in the downstream curing section, producing a downstream IR radiation at a downstream radiation intensity using a downstream catalytic IR heating system to further cure the wet coating.

According to another general aspect, there is provided displacing the coated substrate in a curing room along a curing displacement axis from an upstream curing section towards a downstream curing section; in the upstream curing section, producing an upstream IR radiation at an upstream radiation intensity using an upstream catalytic IR heating system to partially cure the wet coating; in the downstream curing section, producing a downstream IR radiation at a downstream radiation intensity using a downstream catalytic IR heating system to further cure the wet coating; and in at least one of the upstream and downstream curing sections, displacing the coated substrate along a substantially vertical direction.

### BRIEF DESCRIPTION OF THE DRAWINGS

FIG. 1 is a top elevation view of a system for curing a wet coating applied to a substrate in accordance with an embodiment, the system comprising a curing room and a conveyor assembly for conveying the coated substrate through the curing room;

FIG. 2 is a left elevation view of the system of FIG. 1;

FIG. 3 is a cross-section view of the system of FIG. 1 taken along line 3-3 thereof;

FIG. 4 is a cross-section view of the system of FIG. 1 taken along line 4-4 thereof;

FIG. 5 is a front elevation view of the system of FIG. 1;

FIG. 6 is a cross-section view of the system of FIG. 1 taken along line 6-6 thereof;

FIG. 7 is a cross-section view of the system of FIG. 6 taken along line 7-7 thereof;

FIG. 8 is a partial enlarged view of the conveyor assembly of the system of FIG. 7;

FIG. 9 is a partial enlarged view of the conveyor assembly of the system of FIG. 6; and

FIG. 10 is a schematic representation of the conveyor assembly.

### DETAILED DESCRIPTION

The systems and processes described herein allow for curing a film of wet coating applied to a substrate, for instance a wood substrate, by using a gas catalytic infrared (IR) system. The wood substrate can include a natural wood substrate, such as maple, oak, walnut, pine, spruce, fir, cedar, juniper, redwood, yew, or any other hard wood or soft wood substrate, or alternatively, an engineered wood substrate, such as a high-density fiber board, a medium-density fiber board or any other engineered wood substrate. The wet coating can be a water-based coating or a solvent-based coating. In one scenario, the wet coating can be paint, which can include water, but also resins, pigments, additives, any other constituents or any combination thereof.

More particularly, the systems and processes described herein allow for curing a film of paint that has been applied to a wooden cabinet door. It is, however, noted that any other wooden furniture or wooden component (e.g., beam, handrail, countertop, molding, etc.) that has been coated with a film of paint can be dried and cured using the systems and processes described herein. Coating applied to substrates being at least partially made of material different from wood could also be at least partially cured by the systems and processes described herein.

In one implementation, the system can include a curing room for receiving the coated substrate, for instance the coated wood substrate, and a gas catalytic IR system, provided in the curing room, to cure the wet coating using IR heat. The gas catalytic IR system produces medium to long IR waves, which allow the IR radiation to be evenly absorbed by the wet coating, rather than by the substrate itself, as it can be the case when using an electric IR system, for example. The curing room can be dividable along a longitudinal axis—or curing displacement axis—thereof into a plurality of curing sections and can for instance include at least an upstream curing section and a downstream curing section, and the system can further include a conveyor assembly, for conveying the coated wood substrate through the upstream curing section and then through the downstream curing section of the curing room and/or from the upstream curing section to the downstream curing section.

A possible embodiment of a system for curing a wet coating of a coated substrate is disclosed in U.S. patent application Ser. No. 17/199,842, filed on Mar. 12, 2021, and entitled “SYSTEM AND PROCESS FOR CURING A WET COATING APPLIED TO A SUBSTRATE”, the disclosure of which is hereby incorporated by reference in its entirety. As detailed below, the present disclosure differentiates from said disclosure by the displacement of the coated substrates within the system.

In the following description, the terms upstream and downstream should be understood with respect to a displacement of the coated substrate within the curing room (i.e., with respect to the curing displacement axis and/or to any other combined directions). It is further understood that the upstream and downstream curing sections are not necessarily directly adjacent to each other and can be separated from each other by one or more additional intermediate curing sections forming at least partially the curing room. In other words, in the present disclosure, the upstream and downstream curing sections of the curing room can either be directly or indirectly in fluid communication with each other.

In some implementations, other equipment can be used to displace the coated wood substrate through the plurality of curing sections of the curing room. Optionally, the system can be positioned downstream from a paint spraying or brushing automated equipment so as to cure the wet coating (or powder) just after it has been applied to the wood substrate. In one scenario, the system can further include a pre-curing room (or pre-drying room), which can be configured in a sealed engagement (i.e., in a fluid tight manner) with a paint spraying or brushing room which can receive the spraying or brushing equipment and/or with the curing room. For example, the pre-curing room can include an air stream inlet for allowing ambient air to flow therethrough so as to circulate into the drying—or curing—room from the upstream curing section towards the downstream curing section. In one implementation, as detailed below, the pre-curing room can include one or more air filtering elements at the air stream inlet so that ambient air can be filtered prior to being received within the curing room. As detailed below, the conveyor assembly can be configured to displace the substrate in a plurality of directions, some of them being transverse, for instance perpendicular, to other ones.

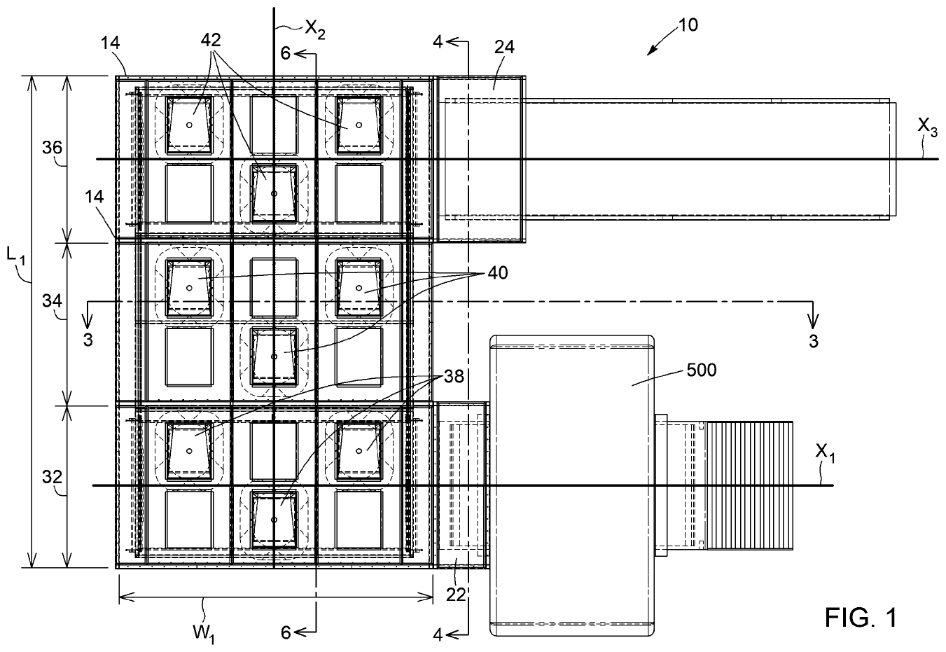

Referring now to the drawings, and more particularly to FIGS. 1 to 9, there is shown a system 10 for curing a wet coating of a coated substrate in accordance with an embodiment. The system comprises a curing room 14 having a curing room inlet 22 and a curing room outlet 24 spaced apart from each other, the curing room 14 being configured to receive the coated substrate being introduced at the curing room inlet 22 thereof along a first displacement axis X₁. In the embodiment shown, the curing room inlet 22 and the curing room outlet 24 are spaced apart from each other considered in a direction transverse, for instance perpendicular, to the first displacement axis X₁. It could also be conceived a curing room wherein the curing room inlet 22 and the curing room outlet 24 would be spaced apart from each other considered along the first displacement axis X₁ or considered along a substantially vertical direction.

The system 10 further comprises a conveyor assembly 100 for conveying the coated substrate through the curing room 14 from the curing room inlet 22 towards the curing room outlet 24 at least along a second displacement axis X₂— or curing displacement axis X₂— transverse to the first displacement axis X₁. The system 10 further comprises a gas catalytic IR system, provided in the curing room 14, for producing an infrared radiation to partially cure the wet coating while the coated substrate is being displaced through the curing room 14 along the second displacement axis X₂ or curing displacement axis X₂ and/or when the coated substrate is in at least one of the upstream and downstream curing sections.

As detailed below, the conveyor assembly 100 is for conveying the coated substrate at least from the upstream curing section of the curing room 14 towards the downstream curing section of the curing room 14 along the curing displacement axis X₂. The conveyor assembly 100 is also configured for displacing the coated substrate along a substantially vertical direction in at least one of the upstream and downstream curing sections, in order to further reduce a footprint of the system 10.

### Curing Room (Drying Room)

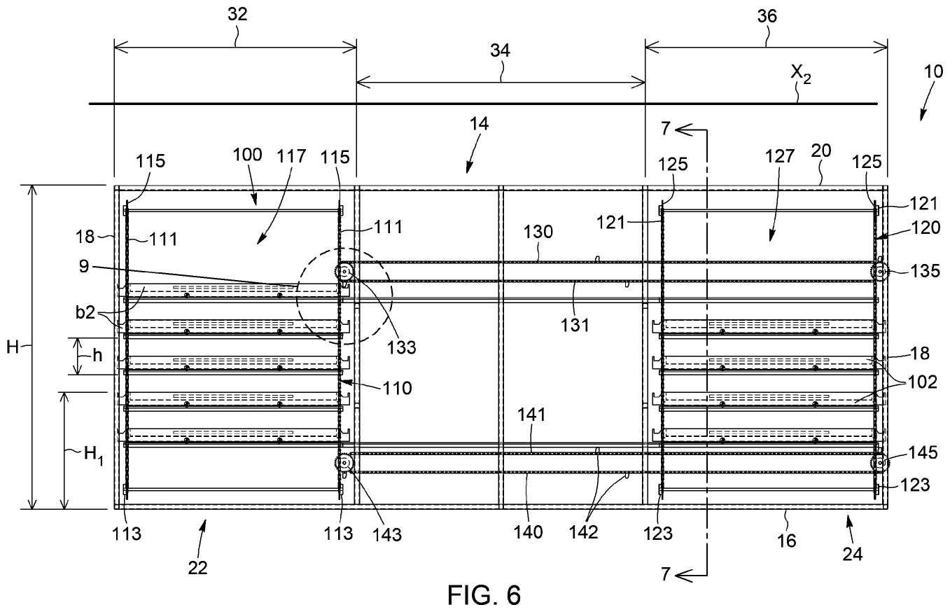

Referring back to the implementation of FIGS. 1 to 6, and as best shown in FIG. 6, the curing room 14 (or drying room 14) of the system 10 is for receiving the coated wood substrate therein. The curing room 14 includes a floor 16, which has a floor periphery, and walls 18, which substantially upwardly extend from the floor 16 at the floor periphery thereof. The curing room 14 further includes a ceiling 20, the curing room inlet 22, which can be formed in one of the walls for example, as well as the curing room outlet 24, which can be formed in another one of the walls. In the implementation of FIG. 6, the curing room outlet 24 is located opposite to the curing room inlet 22, so that the coated wood substrate can be displaced through the curing room 14, from the curing room inlet 22 towards the curing room outlet 24, along the second displacement axis X₂ of the curing room 14 to allow continuous curing operations. The curing room 14 can take any shape, size or configuration, as long as it allows the wet coating to be substantially fully cured once it has travelled through the curing room 14, as it will be described in more detail below, at least along the second displacement axis X₂.

In the embodiment shown, as represented for instance in FIG. 6, the curing room 14 can include (or be dividable along the second displacement axis X₂ into, i.e., dividable along the curing displacement axis X₂ into) at least the upstream curing section 32 and the downstream curing section 36. As detailed below and represented in FIG. 1, the upstream curing section 32 can include gas catalytic IR heaters 38 or upstream gas catalytic IR heaters for producing an upstream IR radiation, at an upstream radiation intensity. The upstream IR radiation can thus be emitted from the upstream gas catalytic IR heaters 38 towards the exposed wet coating of the coated wood substrate, so it can be cured, at least in part. Similarly, the downstream curing section 36, which is positioned downstream from the upstream curing section 32, either directly or indirectly, can include gas catalytic IR heaters 42 or downstream gas catalytic IR heaters for producing a downstream IR radiation, at a downstream radiation intensity, which can be lower than the upstream radiation intensity. The downstream IR radiation can thus be emitted from the downstream gas catalytic IR heaters 42 towards the remaining wet coating, so it can be fully cured.

Still referring to the implementation of FIGS. 1 to 6, optionally, the system 10 can include an intermediate curing section 34, positioned between the upstream curing section 32 and the downstream curing section 36 (i.e., downstream, either directly or indirectly, the upstream curing section 32 and upstream, either directly or indirectly, the downstream curing section 36). Similarly, the intermediate curing section 34 can include intermediate gas catalytic IR heaters 40 or intermediate gas catalytic heaters for producing an intermediate IR radiation, at an intermediate radiation intensity, which can be lower than the upstream radiation intensity and/or can be higher than the downstream radiation intensity. The intermediate IR radiation can thus be emitted from the intermediate gas catalytic heaters 40 towards the remaining wet coating, so it can be cured (e.g., bottom up), at least in part, prior to the coated wood substrate reaching the downstream curing section 36. It is noted that each one of the upstream, intermediate and downstream curing sections 32, 34, 36 of the curing room 14 can include one or more gas catalytic IR heater(s), as long as each curing section produces sufficient IR radiation to heat the film of wet coating, at least in part.

It is appreciated that the shape and the configuration of the curing room, as well as the number, configuration and relative position of the sections thereof can vary from the embodiment shown.

### Conveyor Assembly

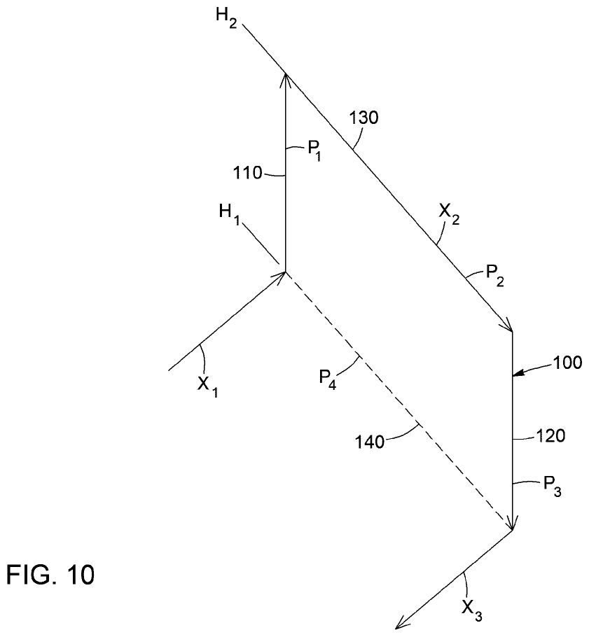

As best shown in FIGS. 1 and 10, the system 10 is configured for the cured coated substrate to be removed from the curing room 14 (for instance at the curing outlet 24 thereof) along a third displacement axis X₃ substantially parallel to and spaced apart from the first displacement axis X₁. For instance, in the embodiment shown, the cured coated substrate is removed from the curing room along the third displacement axis X₃ in a direction opposed to the introduction direction (i.e., a direction opposed to the direction of the introduction of the coated substrate along the first displacement axis X₁ into the curing room 14 (for instance at the curing room inlet 22 thereof)). The first, second and third displacement axes, X₁, X₂, X₃ can thus form a trajectory corresponding to a boustrophedon in the planar view (as seen in FIG. 1) with respect to the direction of travel of the coated substrate, when viewed from above.

In the embodiment shown, the second displacement axis X₂ is substantially perpendicular to the first and third displacement axes X₁, X₃.

In the embodiment shown, the system 10 is also configured to displace the coated substrate along a substantially vertical direction in the curing room 14, for instance in at least one of the upstream and downstream curing sections 32, 36 (in both of them, in the embodiment shown).

In the embodiment shown, as represented for instance in FIG. 6, the conveyor assembly 100 comprises an upstream vertical conveyor 110 in the upstream curing section 32, configured to displace the coated substrate in a vertical direction in the upstream curing section (for instance in an ascending vertical direction). The conveyor assembly 100 further comprises a downstream vertical conveyor 120 in the downstream curing section 34, configured to displace the coated substrate in a vertical direction in the downstream curing section 36 (for instance in a descending vertical direction).

The conveyor assembly 100 also comprises a curing conveyor 130 to displace the coated substrate from the upstream curing section 32 to the downstream curing section 36 (via the intermediate curing section 34, in the embodiment shown) along the second displacement axis X₂ (or curing displacement axis X₂). In other words, the curing conveyor 130 extends at least partially in the intermediate curing section 34 and partially in at least one of the upstream and downstream curing sections 32, 36.

In the embodiment shown, the conveyor assembly 100 further comprises a return conveyor 140 displaceable along the second displacement axis X₂, in a direction opposed to the direction of the coated substrate conveyed by the curing conveyor 130.

For example, the conveyor assembly 100 can comprise a gravity roller conveyor, a power belt conveyor, a skate wheel conveyor, a powered roller conveyor, or any other conveyor which can convey the coated wood substrate through the curing room 14 from the curing room inlet 22 to the curing room outlet 24.

In the embodiment shown, the conveyor assembly 100 comprises a plurality of substrate-supporting members 102 or substrate-conveying members 102 or substrate-conveying plates 102 or substrate-conveying trays 102, for instance substantially rectangular in shape. As best shown in FIG. 6, the substrate conveying trays 102 are displaceable in a vertical direction in the upstream and downstream curing sections 32, 36 via the upstream and downstream vertical conveyors 110, 120.

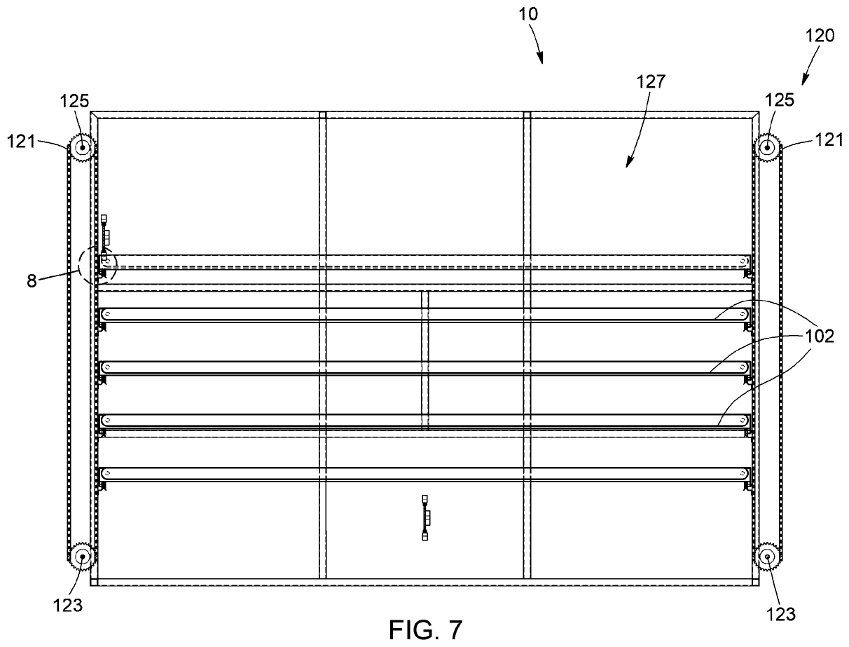

As best shown in FIGS. 6 and 7, in the embodiment shown, each of the vertical conveyors 110, 120 comprises four pairs of vertically spaced-apart pulleys 113, 115, 123, 125 with four closed loops 111, 121 (for instance four endless chains) rotating about the pulleys of a corresponding pair. In other words, each of the vertical conveyors comprises a plurality (four, in the embodiment shown) of conveyor belts. For instance, the four closed loops 111, 121 extend substantially parallel to each other and extend along a vertical direction. The four endless chains or closed loops thus at least partially delimit, respectively, substantially parallelepipedal upstream and downstream conveying chambers 117, 127. In the embodiment shown, at least one pulley of each pair is powered.

For instance, the four endless chains or closed loops 111, 121 of each of the vertical conveyors 110, 120 are arranged at or in the vicinity of corners of at least one of the substrate-conveying trays 102, so as to displace the substrate-conveying trays 102 along a substantially vertical direction in the corresponding one of the upstream and downstream conveying chambers 117, 127. In the embodiment shown, each of the upstream and downstream conveying chambers 117, 127 is shaped and dimensioned to displace simultaneously a plurality (for instance five) substrate-conveying trays 102 substantially parallel to each other.

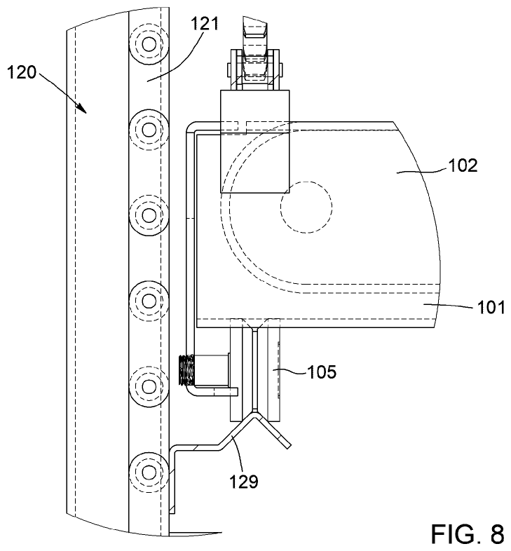

For instance, as best shown in FIG. 8, the substrate-conveying trays 102 are mounted to the endless chains 111, 121 in a removable manner, so as to be displaced from one of the upstream and downstream vertical conveyors 110, 120 to the other one of the upstream and downstream vertical conveyors. For instance, as best shown in FIG. 8, tray-supporting members 129 are mounted to the closed loop 121 which are shaped and dimensioned to support a lower portion or surface of the substrate-conveying tray 102. In the embodiment shown, wheels 105 are mounted to a tray body 101 (to a lower portion thereof) of the substrate-conveying tray 102 so as to ease the displacement of the substrate-conveying tray 102 between the different components of the conveyor assembly 100.

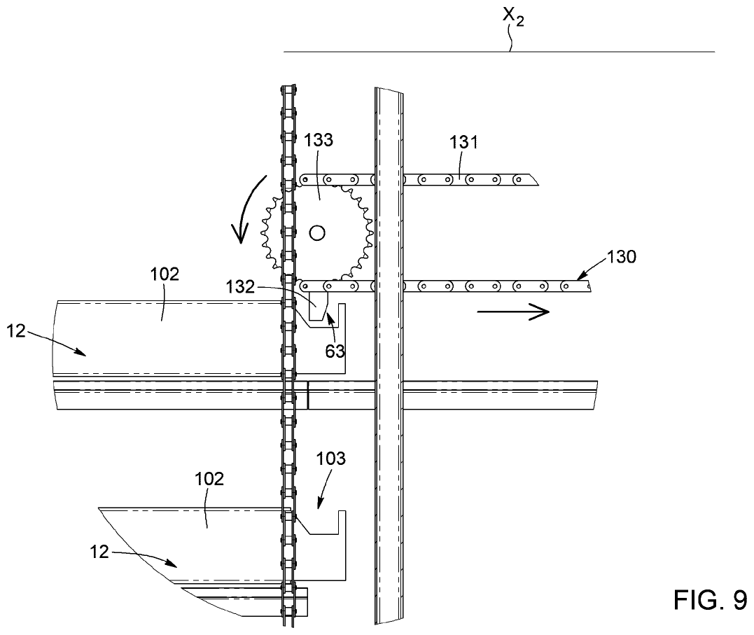

As best shown in FIGS. 6 and 9, in the embodiment shown, each of the curing conveyor 130 and the return conveyor 140 comprises at least one respective endless chain 131, 141 or closed loop, substantially parallel to each other and extending along a horizontal direction, spaced apart from each other along a substantially vertical direction in the embodiment shown. Each of the closed loops 131, 141 surrounds a respective pair of horizontally spaced-apart trolleys 133, 135, 143, 145, at least one of said trolleys being powered (in other words, each of the curing conveyor and the return conveyor comprises at least one horizontally extending conveyor belt).

As best shown in FIG. 9, the curing conveyor 130 comprises at least one tray-engaging member 132 mounted to or formed integral with the endless chain 131 and shaped and dimensioned to engage one of the substrate-conveying trays 102. For instance, a recess 103 is formed in the substrate-conveying tray 102 (for instance in an edge thereof, for instance in the tray body thereof) that is shaped and dimensioned to receive/engage/couple with the tray-engaging member 132 (or tray-coupling member 132). Upon removable engagement of the tray-coupling member 132 with the recess 103 of the substrate-conveying tray 102 and upon rotation of the closed loop 131 about the horizontally spaced-apart trolleys 133, 135, the substrate-conveying tray 102 is disconnected/disengaged from the upstream vertical conveyor 110 (for instance, disengaged from the closed loops 111 thereof, and for instance disengaged from the tray-supporting members 129 of the upstream vertical conveyor) and displaced along the second displacement axis X₂ via the rotating endless chain 131 of the curing conveyor 130.

As best shown in FIG. 6, once the substrate-conveying tray 102 has reached the downstream curing section 36 and the downstream conveying chamber 127, the substrate-conveying tray 102 is disengaged/disconnected from the curing conveyor 130. For instance, the tray-coupling member 132 is disengaged from the recess 103 upon rotation of the closed loop 131 about the distal pulley 133 (considered with respect to the upstream curing section 32) or downstream pulley 135. In the embodiment shown, the substrate-conveying tray 102 is thus placed/dropped/engaged with at least a portion of the downstream vertical conveyor 120.

In the embodiment shown, the downstream vertical conveyor 120 is substantially similar to the upstream vertical conveyor 110: the downstream vertical conveyor 120 comprises, for instance, a plurality of tray-supporting members 129 mounted to or formed integral with the closed loops 121 of the downstream vertical conveyor 120, in order to support a lower portion of the substrate-conveying tray 102, for instance at, or in the vicinity of, corners thereof.

Upon rotation of the closed loops 121 or endless chains 121 about the corresponding vertically spaced-apart pulleys 123, 125, the substrate-conveying tray 102 is displaced vertically in a downward or descending direction within the downstream conveying chamber 127 (i.e., is downwardly displaced within the downstream curing section 36 of the curing room 14).

In the embodiment shown, the return conveyor 140 has a structure substantially similar to the curing conveyor 130. For instance, the return conveyor 140 comprises a plurality of tray-coupling members 142 mounted to or formed integral with the closed loop or endless chain 141 of the return conveyor and shaped and dimensioned to engage one of the substrate-conveying trays 102. For instance, the tray-coupling member 142 is configured to engage in a removable manner a lower portion of the substrate-conveying member (for instance a portion of the wheels 105 mounted to the tray body 101). Upon removable engagement of the tray-coupling member 142 with the substrate-conveying tray 102 and upon rotation of the closed loop 141 about the horizontally spaced-apart trolleys 143, 145, the substrate-conveying tray 102 is disconnected/disengaged from the downstream vertical conveyor 120 (for instance disengaged from the closed loops 121 thereof, and for instance disengaged from the tray-supporting members 129 of the downstream vertical conveyor 120) and displaced along the second displacement axis X₂ via the rotating endless chain 141 of the return conveyor 140 in a direction opposed to the displacement of the substrate-supporting tray 102 upon cooperation with the curing conveyor 130.

It is thus understood that each of the substrate-conveying trays 102 follows a closed circuit or closed loop upon successive cooperation with the upstream vertical conveyor 110, the curing conveyor 130, the downstream vertical conveyor 120 and the return conveyor 140. In other words, as schematically represented in FIG. 10, each of the substrate-conveying trays 102 is successively displaced/translated along a substantially vertical ascending path P₁ within the upstream curing section 32, a first substantially horizontal path P₂ from the upstream curing section 32 to the downstream curing section 36, a substantially vertical descending path P₃ within the downstream curing section 36 and a second substantially horizontal path P₄, in a direction opposed to the first substantially horizontal path P₂, from the downstream curing section 36 to the upstream curing section 32.

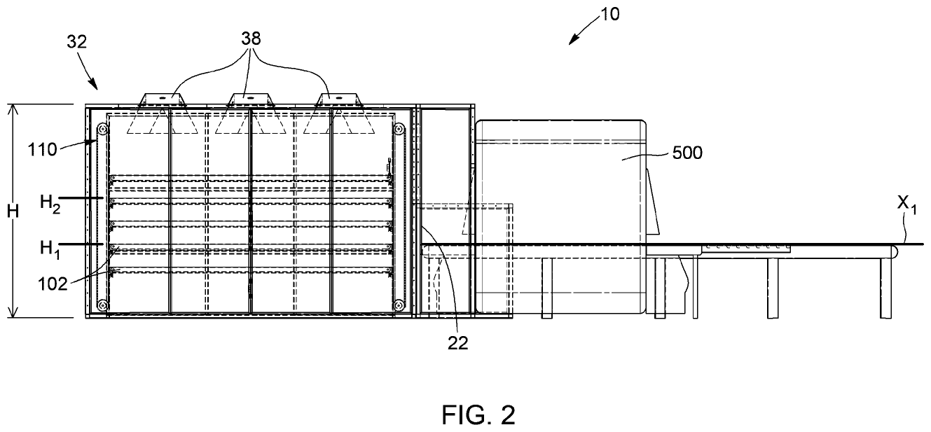

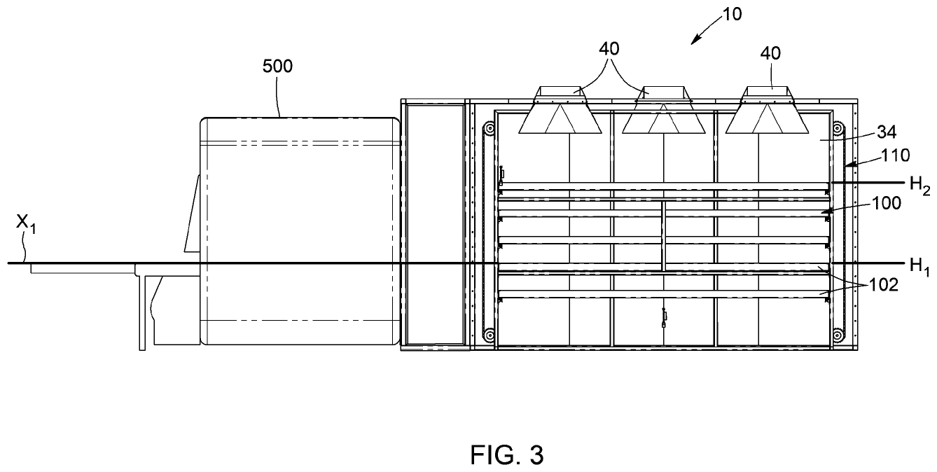

In the embodiment shown, as represented in FIGS. 2 and 3, the coated substrate is introduced at the curing room inlet 22 along the first displacement axis X₁ at a first vertical position H₁. The coated substrate is then placed onto one of the substrate-conveying trays 102 in the upstream curing section 32. The substrate-conveying tray 102 and the coated substrate are then displaced together via the upstream vertical conveyor 110 along the first substantially vertical ascending path P₁ to a second vertical position H₂ higher than the first vertical position H₁. It could be conceived a curing system that would be configured to directly translate the coated substrate from the upstream curing section 32 to the downstream curing section 36 along the first substantially horizontal path P₂ without translating the coated substrate within the upstream curing section 32 along a substantially vertical direction. It could also be conceived a curing system wherein the coated substrate would be lowered from a first vertical position to a second vertical position in the upstream curing section 32, before being displaced towards the downstream curing section 36.

In the embodiment shown, the substrate-conveying tray 102 and the coated substrate are displaced together successively along the substantially vertical ascending path P₁, the first substantially horizontal path P₂ and the substantially vertical descending path P₃. In the embodiment shown, when the substrate-conveying tray 102 and the coated substrate, in a substantially cured state, have reached in the downstream curing section 36 a vertical position corresponding substantially to the first vertical position H₁, the cured substrate is removed from the substrate-conveying tray 102 and is removed from the curing room 14 at the curing room outlet 24. For instance, the curing system 10 is configured for the cured coated substrate to be removed from the curing room 14 along the first displacement axis X₁, for instance in a direction opposed to the introduction direction at the curing room inlet 22.

It could be conceived a curing system wherein the cured coated substrate would be removed from the curing room 14 at a vertical position different from the introduction vertical position H₁ and/or wherein the coated substrate would be removed at the curing room outlet 24 along an axis different from the first displacement axis X₁ or along the first displacement axis X₁ in the same direction as the introduction direction at the curing room inlet 22.

It is thus understood that when the substrate-conveying tray 102 is displaced along the second substantially horizontal path P₄, the tray 102 does not support a coated substrate (i.e., the tray is in a free or empty configuration). When the substrate-conveying tray 102 reaches the upstream curing section 32, a new coated uncured substrate can be placed thereon.

It is appreciated that the shape and the configuration of the conveyor assembly 100, as well as the shape, the configuration and the relative location of the upstream and downstream vertical conveyors 110, 120, the curing conveyor 130 and the return conveyor 140 thereof, can vary from the embodiment shown. The disclosure is not limited to a conveyor assembly that would comprise conveyor belts and any other conveyor systems configured to displace coated substrates in the curing room could be conceived.

It could for instance also be conceived a curing system wherein the curing room inlet 22 and the curing room outlet 24 would be arranged at a substantially similar position along the second displacement axis X₂, at opposing sides of the curing room 14. In other words, instead of introducing and removing the coated substrate at two distinct positions along the second displacement axis X₂, for instance at a same side of the curing room 14, as represented in FIG. 1, the curing system could be designed so that the curing room outlet 24 would be arranged in a continuity of the curing room inlet 22 considered along the first displacement axis X₁, the curing room outlet 24 and inlet 22 being on opposing sides of the curing room 14. The substrate-conveying tray 102 would thus be translated along the above-described paths P₁, P₂, P₃ and P₄ with the coated substrate; once the cured substrate would have reached the first vertical position H₁ in the upstream curing section 32, the cured substrate would be removed from the curing room 14 while a new uncured coated substrate would be placed onto the substrate-conveying tray 102.

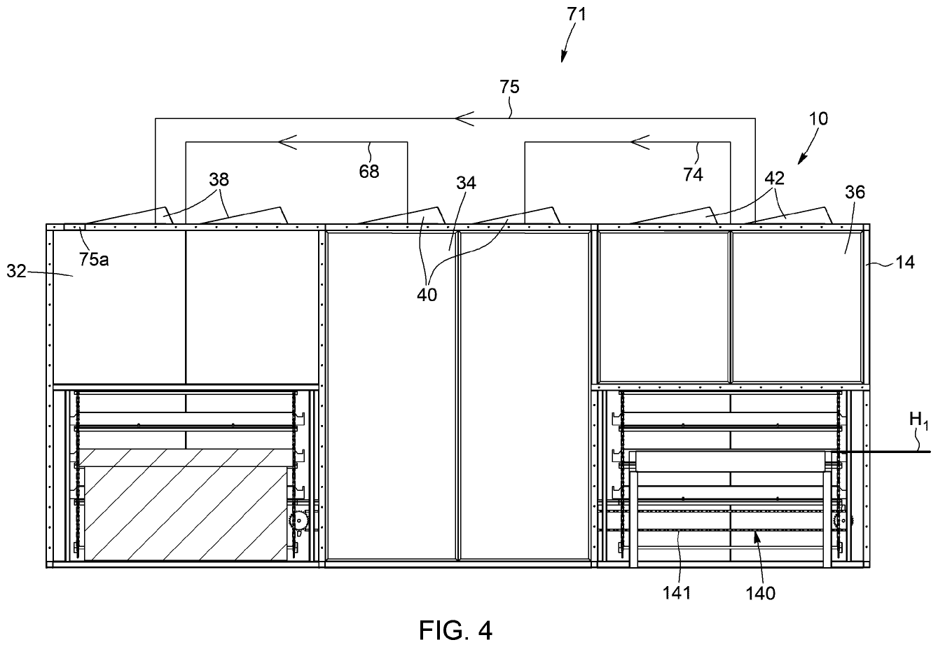

In the embodiment shown, as represented in FIG. 4, the first vertical position H₁ is different from a lowest vertical position of the upstream and downstream vertical conveyors 110, 120. In the embodiment shown, as represented in FIG. 2, the second vertical position H₂ is different from a highest vertical position of the upstream and downstream vertical conveyors.

As best shown in FIG. 1, a length Li of the curing room 14 considered along the second displacement axis X₂ is comprised for instance between about 100 cm and about 400 cm, between about 150 cm and about 350 cm, between about 200 cm and about 300 cm, or is about 250 cm. As best shown in FIG. 1, a width W₁ of the curing room 14 considered along the first displacement axis X₁ is comprised for instance between about 50 cm and about 250 cm, between about 75 cm and about 225 cm, between about 100 cm and about 200 cm, or is about 150 cm. In the illustrated embodiment, the length Li is greater than the width W₁. For instance, the length Li is greater than about 120%, about 140%, or about 160% of the width W₁.

In the illustrated embodiment, the upstream, intermediate and downstream curing sections 32, 34, 36 have a substantially similar length considered along the second displacement axis X₂.

As best shown in FIG. 6, a height H of the curing room 14 is comprised for instance between about 50 cm and about 200 cm, between about 75 cm and about 150 cm, or is about 100 cm.

In the illustrated embodiment, the first vertical position H₁ represents between about 10% and about 50%, between about 15% and about 40%, or about 30% of the height H of the curing room 14.

In the illustrated embodiment, the second vertical position H₂ represents between about 40% and about 90%, about 50% and about 70%, or about 65% of the height H of the curing room 14.

In the illustrated embodiment, the second vertical position H₂ is lower than the height H of the curing room 14. For instance, the second vertical position H₂ is vertically spaced apart from a lower portion of the gas catalytic IR system (i.e., spaced apart from the gas catalytic IR heaters 38, 40, 42).

In the illustrated embodiment, as best shown in FIG. 6, adjacent or successive substrate-conveying trays 102 are vertically spaced-apart from each other in the downstream and upstream vertical conveyors 120, 110 at a distance h. In the illustrated embodiment, the distance h is smaller than about 50%, about 30%, or about 15% of the height H of the curing room 14.

In one implementation, the coated wood substrate 12 on the substrate-conveying trays 102 can be conveyed through the curing room 14, either in at least one of the upstream and downstream curing sections 32, 36, in a substantially vertical direction, or from the upstream curing section 32 to the downstream curing section 36, in a substantially horizontal direction, at a speed of between about 0.50 m/s and about 3 m/s, of between about 1 m/s and about 2.5 m/s, or of between about 1.5 m/s and about 2 m/s. Additionally, the distance between the curing room inlet 22 and the curing room outlet 24 can be between about 3 meters and about 20 meters, between about 5 meters and about 18 meters, or between about 7 meters and about 16 meters. The speed may be the same in both vertical and horizontal directions, or the speed may be different. In one implementation, the conveyors may run continuously (i.e., at a constant speed), for example for water-based coatings which may not require flash-off. In an alternative implementation, the horizontal and/or vertical conveyors may be configured to make stops, for example to permit flash-off of solvent-based coating on the coated substrate after application of the coating. The speed of the conveyors may also be adjusted, for example, to correspond to the speed of application of the coating (e.g., to the speed at which coating is sprayed onto the substrate). The acceleration and deceleration rates of each one of the conveyors may also be adjusted.

In one implementation, the coated wood substrate 12 can be conveyed through the curing room 14 from the upstream curing section 32 to the downstream curing section 36 in a horizontal orientation, with a bottom surface thereof facing the floor 16 of the curing room 14 and a top surface thereof facing the ceiling 20 of the curing room or vice versa, for example. It can also be understood that a plurality of spaced apart coated wood substrates 12 can be conveyed, one after the other, through the curing room 14 via the conveyor assembly 100. Alternatively, a plurality of coated wood substrates 12 can be stacked, one on top of the other, and conveyed, providing a sufficient distance between adjacent coated wood substrates 12, so that the IR radiation emitted in the different curing room sections of the curing room 14 can reach the wet coating to be cured.

### Gas Catalytic IR System Comprising a Plurality of Gas Catalytic IR Heaters

As mentioned above, the system 10 can comprise a gas catalytic IR system provided in the curing room 14 for producing an infrared radiation to partially cure the wet coating while the coated substrate is being displaced through the curing room 14 along the curing displacement axis X₂ and/or while the coated substrate 12 is vertically displaced in at least one of the upstream and downstream curing sections 32, 36 of the curing room 14. For instance, the upstream curing section 32 can include one or more upstream gas catalytic IR heater(s) 38 of the gas catalytic IR system to heat the wet coating using an upstream IR radiation, at an upstream IR radiation intensity (at an upstream IR wavelength), to partially cure the film of wet coating, bottom up or inside out (i.e., from a lower layer of the wet coating upwardly towards an upper layer of the wet coating). On the other hand, the downstream curing section 36 can include one or more downstream gas catalytic IR heater(s) 42 of the gas catalytic IR system to further heat the remaining wet coating, bottom up, using a downstream IR radiation, at a downstream IR radiation intensity (at a downstream IR wavelength), being lower than the upstream IR radiation intensity (being lower than the upstream IR wavelength), to fully cure the film of wet coating, so as to produce a cured coated wood substrate.

The upstream IR radiation being produced by the upstream gas catalytic IR heater(s) 38 directed towards the exposed wet coating can thus be evenly absorbed, at least in part, by the wet coating applied to the substrate (for instance the wood substrate 12) being displaced through the upstream curing section 32. The wet coating can thus be cured, from a lower layer of the wet coating towards an upper layer of the wet coating. The water can therefore be expelled from the wet coating, under excitement of the water molecules (rather than by evaporation), in the upstream curing section 32 of the curing room 14, increasing a temperature and/or a humidity rate, of an air stream produced in the upstream curing section 32. It is noted that the wavelength of the upstream IR radiation produced by the upstream IR radiation heater(s) 38 needs to be such that the film of wet coating is cured bottom up (i.e., inside out). Indeed, if the top layer of the wet coating is cured first, the water can remain trapped inside the film of coating. The trapped water can thus burst out, causing little craters or poppings (i.e., the obtained coated wood substrate 12 may thus need to be polished or scrapped). Once the partially coated wood substrate 12 has reached the downstream curing section of the curing room, the downstream IR radiation produced by the downstream gas catalytic IR heater(s) 42 directed towards the remaining wet coating can thus be evenly absorbed, at least in part, by the wet coating, so it can be fully cured, inside out. The water remaining in the wet coating can also be expelled therefrom in the downstream curing section 42 of the curing room 14.

In the embodiment shown, gas catalytic IR heaters 38, 40, 42 arranged in the curing room 14 (for instance in the upstream, intermediate and downstream curing sections 32, 34, 36 thereof) have a similar shape. Possible embodiment of the gas catalytic IR heaters 38, 40, 42 is disclosed in U.S. patent application Ser. No. 17/199,842, filed on Mar. 12, 2021, and entitled “SYSTEM AND PROCESS FOR CURING A WET COATING APPLIED TO A SUBSTRATE”, the disclosure of which is hereby incorporated by reference in its entirety.

### Pre-Curing Room (or Flash-Up Room)

In one implementation, as best shown in FIGS. 1 to 3, the system 10 can further include a pre-curing room 500 for receiving the coated wood substrate 12 once it has been coated by a spraying or brushing equipment (not represented). In other words, in the embodiment shown, the pre-curing room 500 is downstream of the wet coating spraying or brushing equipment and upstream of the curing room 14, for instance upstream of the upstream curing section 32 thereof or upstream of the curing room inlet 22 thereof, considered along the first displacement axis X₁ in the embodiment shown.

### Ventilation System

In one implementation, as represented for instance in FIG. 4, the system 10 can further include a ventilation system 71 for directing the upstream heated air stream (with a high content of water) from the upstream curing section 32 towards the downstream curing section 36 or vice versa. The ventilation system 71 might be configured for uniformizing the heated air stream(s) in at least one of the upstream, intermediate and/or downstream curing sections 32, 34, 36 by recirculating the heated air stream(s) in the respective section and/or recirculating the heated air stream from at least one of the upstream, intermediate and/or downstream curing sections 32, 34, 36 towards at least another one of the upstream, intermediate and/or downstream curing sections 32, 34, 36.

As used herein, the term “uniformize” may be understood as designating a difference of less than about 10%, about 5%, about 2%, or about 1% between the maximum and minimum values of temperatures and/or humidity rates in the corresponding section 32, 34, 36 of the curing room 14. Moreover, as detailed below, the ventilation system 71 is also shaped and dimensioned for cooling the cured coated substrate exiting at the curing room outlet 24. In other words, the ventilation system 71 is configured for circulating the heated and/or humid air contained in at least one of the upstream, intermediate or downstream curing sections 32, 34, 36 towards at least another one of the curing sections 32, 34, 36 (i.e., comprises at least one intersection recirculation duct) or within at least one of the upstream, intermediate or downstream curing sections 32, 34, 36 (i.e., comprises at least one intrasection recirculation duct). In other words, the ventilation system 71 is shaped and dimensioned to at least partially recycle, within the curing room 14, the heated air stream produced in at least one of the different sections 32, 34, 36 thereof.

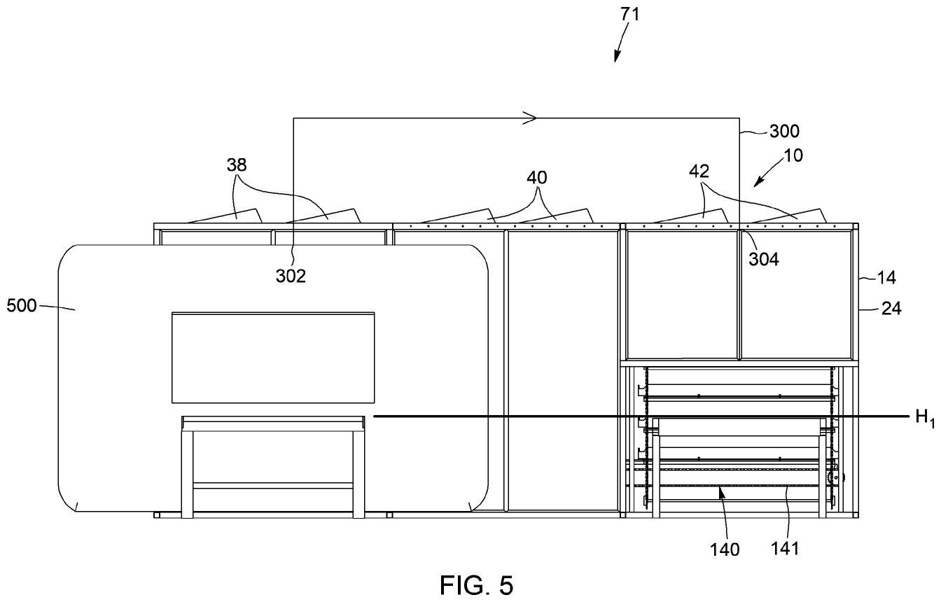

As shown in FIG. 5, the ventilation system 71 can comprise at least one cooling (or temperature-lowering) duct 300 comprising a cooling duct inlet 302 at the pre-curing room 500 (i.e., fluidly connected with an inner volume of the pre-curing room 500) and a cooling duct outlet 304 at the curing room outlet 24 or in the vicinity thereof. The cooling duct 300 is thus shaped and dimensioned to direct an airflow (for instance cool ambient air) received in the pre-curing room 500 at least partially towards the curing room outlet 24 in order to lower a temperature of the cured coated substrates.

In the embodiment shown, as represented for instance in FIG. 4, the ventilation system 71 further comprises at least one exhaust 75a having an inlet at the upstream curing section 32 and an outlet for expelling air out of the curing room 14, when needed. Other exhausts could be arranged in fluid communication with an inner volume of the curing room 14 (for instance at the intermediate and/or downstream curing sections 34, 36 thereof).

As best shown in FIG. 4, the ventilation system 71 can optionally include an intersection recirculation duct 75 having an inlet at the downstream curing section 36 and an outlet at the upstream curing section 32 of the curing room 14 for recirculating the heated air stream produced in the downstream curing section 36 towards the upstream curing section 32. The intersection recirculation duct 75 can either directly fluidly connect the downstream and upstream curing sections 36, 32, and/or, as in the embodiment shown, comprise a first intersection recirculation duct 74 having an inlet at the downstream curing section 36 and an outlet at the intermediate curing section 34 for recirculating the heated air stream produced in the downstream curing section 36 towards the intermediate curing section 34; and a second intersection recirculation duct 68 having an inlet at the intermediate curing section 34 (proximate, for instance upstream of, the outlet of the first recirculation duct 74) and an outlet at the upstream curing section 32 for recirculating the heated air stream produced in the intermediate curing section 34 towards the upstream curing section 32. In other words, the intersection recirculation duct 75 may be divided, as in the embodiment shown, into two distinct recirculation sub-ducts (first and second intersection recirculation ducts 74, 68) for recirculating the heated air stream produced in the downstream curing section 36 towards the upstream curing section 32 via the intermediate curing section 34.

Recirculating the air from the downstream curing section 36 towards the intermediate curing section 34, and from the intermediate curing section 34 towards the upstream curing section 32 (or possibly in addition to directly from the downstream curing section 36 towards the upstream curing section 32 via the duct 75), can help in uniformizing the water content of the air streams present in the different curing sections 32, 34, 36.

In the embodiment shown, the ventilation system 71 further comprises at least one intrasection recirculation duct (not represented) having an inlet and an outlet at a given one of the upstream, intermediate and downstream curing sections 32, 34, 36 for uniformizing the heated air stream produced within the corresponding one of the upstream, intermediate and downstream curing sections 32, 34, 36.

It is appreciated that the shape, the configuration, and the location of the ventilation system 10, as well as the shape, the configuration, the number and/or the relative arrangement of the intrasection recirculation ducts, the intersection recirculation ducts 68, 74 and/or the cooling duct 300 thereof can vary from the embodiment shown.

### Process Implementations

According to another aspect of the disclosure, there is provided a process for curing a wet coating of a coated substrate.

The process for curing a wet coating of a coated substrate according to embodiments of the present disclosure may be carried out with a system 10 as described above.

For instance, the process comprises introducing the coated substrate in an upstream curing section 32 of a curing room 14 along a first displacement axis X₁; in the upstream curing section 32, producing an upstream infrared radiation at an upstream radiation intensity using an upstream catalytic infrared heating system having upstream heaters 38 to partially cure the wet coating; displacing the coated substrate along a second displacement axis X₂ transverse to the first displacement axis X₁ from the upstream curing section 32 to a downstream curing section 36 of the curing room 14; in the downstream curing section 36, producing a downstream infrared radiation at a downstream radiation intensity, for instance being lower than the upstream radiation intensity, using a downstream catalytic infrared heating system having downstream heaters 42 to further cure the wet coating.

According to another possible embodiment, the process comprises displacing the coated substrate in a curing room 14 along a curing displacement axis through an upstream curing section 32 and then through a downstream curing section 36 and/or from the upstream curing section 32 to the downstream curing section 36; in the upstream curing section 32, producing an upstream infrared radiation at an upstream radiation intensity using an upstream catalytic infrared heating system having upstream heaters to partially cure the wet coating; in the downstream curing section 36, producing a downstream infrared radiation at a downstream radiation intensity, for instance being lower than the upstream radiation intensity, using a downstream catalytic infrared heating system having downstream heaters to further cure the wet coating; and in at least one of the upstream and downstream curing sections, displacing the coated substrate along a substantially vertical direction.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications may come to mind. The scope of the invention is therefore intended to be limited by the scope of the appended claims.

1. A system for curing a wet coating of a coated substrate, the system comprising:
a curing room having a curing room inlet and a curing room outlet, the curing room being configured to receive the coated substrate, and the coated substrate being introduced at the curing room inlet along a first displacement axis,
a conveyor assembly for conveying the coated substrate through the curing room along at least a second displacement axis transverse to the first displacement axis, and
a gas catalytic infrared (IR) system provided in the curing room for producing an IR radiation to partially cure the wet coating while the coated substrate is displaced through the curing room along the second displacement axis.

2. The system according to claim 1, wherein the curing room is dividable along the second displacement axis into at least:
an upstream curing section comprising an upstream catalytic IR heating system of the gas catalytic IR system for producing an upstream IR radiation at an upstream radiation intensity to partially cure the wet coating while the coated substrate is in the upstream curing section; and
a downstream curing section comprising a downstream catalytic IR heating system of the gas catalytic IR system for producing a downstream IR radiation at a downstream radiation intensity lower than the upstream radiation intensity to further cure the wet coating while the coated substrate is in the downstream curing section.

3. The system according to claim 2, further comprising an intermediate curing section positioned between the upstream and downstream curing sections, the intermediate curing section having an intermediate catalytic IR heating system for producing an intermediate IR radiation at an intermediate radiation intensity to partially cure the wet coating.

4. The system according to claim 3, wherein the intermediate radiation intensity is lower than the upstream radiation intensity and higher than the downstream radiation intensity.

5. The system according to claim 3, wherein the conveyor assembly comprises an upstream vertical conveyor in the upstream curing section, a downstream vertical conveyor in the downstream curing section, and an intermediate horizontal conveyor in the intermediate curing section for moving the coated substrate between the upstream and downstream vertical conveyors.

6. The system according to claim 5, wherein the coated substrate is received on a substrate-conveying tray conveyed by the conveyor assembly, the conveyor assembly having an engagement mechanism for selective engagement of the substrate-conveying tray.

7. The system according to claim 6, wherein the engagement mechanism of the conveyor assembly comprises tray-supporting members on the upstream and downstream vertical conveyors configured to support a lower surface of the substrate-conveying tray.

8. The system according to claim 6, wherein the engagement mechanism of the conveyor assembly comprises at least one tray-engaging member on the intermediate horizontal conveyor, and a corresponding recess on the substrate-conveying tray configured to engage the at least one tray engaging member to convey the substrate-conveying tray along the intermediate horizontal conveyor.

9. The system according to claim 6, wherein the intermediate horizontal conveyor comprises a curing conveyor and a return conveyor conveying in a direction opposed to the curing conveyor for conveying the substrate-conveying tray between the upstream and downstream vertical conveyors.

10. The system according to claim 3, further comprising a ventilation system having a recirculation duct for transferring a heated air stream produced in at least one of the upstream, intermediate and downstream curing sections towards at least another one of the upstream, intermediate and downstream curing sections, and/or recirculating the heated air stream within at least one of the upstream, intermediate and downstream curing sections.

11. The system according to claim 10, wherein the recirculation duct comprises two recirculation sub-ducts for recirculating the heated air stream produced in the downstream curing section towards the upstream curing section via the intermediate curing section.

12. The system according to claim 10, further comprising uniformizing the heated air stream in at least one of the upstream, intermediate and downstream curing sections.

13. The system according to claim 10, wherein the ventilation system is shaped and dimensioned for cooling the coated substrate exiting at the curing room outlet.

14. The system according to claim 13, wherein the ventilation system comprises a duct shaped and dimensioned to direct an air flow from the precuring room at least partially towards the curing room outlet for cooling the coated substrate exiting at the curing room outlet.

15. The system according to claim 10, wherein the ventilation system further comprises at least one exhaust at each one of the upstream, intermediate and downstream curing sections for expelling air out of the corresponding curing section.

16. The system according to claim 1, wherein a third displacement axis is parallel to and spaced apart from the first displacement axis, the conveyor assembly conveying the coated substrate into the curing room through the curing room inlet along the first displacement axis, conveying the coated substrate along the second displacement axis, and then conveying the coated substrate out of the curing room through the curing room outlet along the third displacement axis.

17. (canceled)

18. (canceled)

19. (canceled)

20. (canceled)

21. The system according to claim 5, wherein the upstream vertical conveyor conveys the coated substrate from a first vertical position to a second vertical position, and the downstream vertical conveyor conveys the coated substrate from the second vertical position to the first vertical position.

22. (canceled)

23. (canceled)

24. The system according to claim 6, comprising a plurality of substrate-conveying trays, wherein successive ones of the substrate-conveying trays are vertically spaced apart from one another in the upstream and downstream vertical conveyors by a distance smaller than about 15% of a height of the curing room.

25. (canceled)

26. (canceled)

27. A system for curing a wet coating of a coated substrate, the system comprising:
a curing room configured to receive the coated substrate and dividable along a curing displacement axis into at least:
an upstream curing section comprising an upstream catalytic infrared (IR) heating system for producing an upstream IR radiation at an upstream radiation intensity to partially cure the wet coating; and
a downstream curing section comprising a downstream catalytic IR heating system for producing a downstream IR radiation at a downstream radiation intensity, to further cure the wet coating;
a conveyor assembly for:
conveying the coated substrate from the upstream curing section towards the downstream curing section along the curing displacement axis; and for
displacing the coated substrate in a substantially vertical direction in at least one of the upstream and downstream curing sections.

28. (canceled)

29. (canceled)

30. (canceled)

31. (canceled)

32. A process for curing a wet coating of a coated substrate, the process comprising:
displacing the coated substrate in a curing room along a curing displacement axis from an upstream curing section towards a downstream curing section;
in the upstream curing section, producing an upstream IR radiation at an upstream radiation intensity using an upstream catalytic IR heating system to partially cure the wet coating;
in the downstream curing section, producing a downstream IR radiation at a downstream radiation intensity using a downstream catalytic IR heating system to further cure the wet coating; and
in at least one of the upstream and downstream curing sections, displacing the coated substrate along a substantially vertical direction.

33-43. (canceled)
